(19) United States
(12) Patent Application Publication
(10) Pub. No.: US 2023/0304484 A1
(43) Pub. Date: Sep. 28, 2023

(54) MODULAR SUCTION STABILIZER

(71) Applicant: SPM Oil & Gas Inc., Fort Worth, TX (US)

(72) Inventors: Ralph E. HARRIS, Fort Worth, TX (US); Chandu KUMAR, Fort Worth, TX (US)

(73) Assignee: SPM Oil & Gas Inc., Fort Worth, TX (US)

(21) Appl. No.: 18/040,010

(22) PCT Filed: Aug. 18, 2021
(86) PCT No.: PCT/US2021/046585

§ 371 Date: Jan. 31, 2023

Related U.S. Application Data
(60) Provisional application No. 63/067,869, filed on Aug. 19, 2020.

(51) Int. Cl. F04B 11/00; F16L 55/04; F16L 41/03

(52) U.S. Cl. CPC F04B 11/0091; F16L 55/043; F16L 41/03

(57) ABSTRACT

A modular stabilizer is provided for a reciprocating pump. The modular stabilizer includes at least one fluid dampening module incorporating a dampening material and forming a second fluid flow path in fluid communication with the first fluid flow path defined between the entry ports of the suction manifold. The second fluid flow path is an alternate fluid flow path branching from the first fluid flow path.

### FIELD

The disclosure relates to systems, apparatus and methods for a modular suction stabilizer. More specifically, this disclosure relates to a modular pulsation absorber that minimizes vibration related to a hydraulic pump (e.g., the fluid-end and the suction manifold) and trailer.

### BACKGROUND

Hydraulic fracturing (a.k.a. fracking) is a process to obtain hydrocarbons such as natural gas and petroleum by injecting a fracking fluid or slurry at high pressure into a wellbore to create cracks in deep rock formations. The hydraulic fracturing process employs a variety of different types of equipment at the site of the well, including one or more positive displacement pumps, slurry blender, fracturing fluid tanks, high-pressure flow iron (pipe or conduit), wellhead, valves, charge pumps, and trailers upon which some equipment are carried.

Positive displacement pumps are commonly used in oil fields for high pressure hydrocarbon recovery applications, such as injecting the fracking fluid down the wellbore. A positive displacement pump typically has two sections, a power end and a fluid end. The power end includes a crankshaft powered by an engine that drives the plungers. The fluid end of the pump includes cylinders into which the plungers operate to draw fluid from a suction manifold into the fluid chamber or cylinder and then forcibly push out at a high pressure to a discharge manifold, which is in fluid communication with a well head.

Conventional stabilizers used to remove or dampen vibrations in the positive displacement or reciprocating pump suction manifold have a permanent or replaceable collapsible nonmetallic rubber core that compresses when the fluid volume and pressure are high, and expands when there is a drop in fluid pressure or volume. Commonly called a Discharge Suction Stabilizer (DSS), these conventional stabilizers are installed in-line with the suction manifold fluid flow, which causes a reduction in available total liquid volume. These in-line solutions are prone to premature wear and degradation because they are subjected to the harsh slurry fluids that are being pumped at high pressures.

### BRIEF DESCRIPTION OF THE DRAWINGS

FIG. 1 is a side view of an example embodiment of a modular suction stabilizer according to the teachings of the present disclosure; and

FIG. 2 is a perspective view of an example embodiment of a reciprocating pump with a power end and a fluid end according to the teachings of the present disclosure.

### DETAILED DESCRIPTION

There is a need for a suction stabilizer in the form of a suction inlet plenum that has sufficient volume to meet the flow needs of the pump and provide sufficient dynamic pulsation absorption to limit the minimum suction pressures when the pump suction valves open and remove the possibility of cavitation of the slurry through the pump components. The desired solution is one that will not degrade over time. As such, there is a need for a new and improved vibration absorber for trailers and high-pressure reciprocating pumps that solves the vibration issue, does not limit fluid volume, does not degrade, and allows for customization according to pump configuration, operation, and condition.

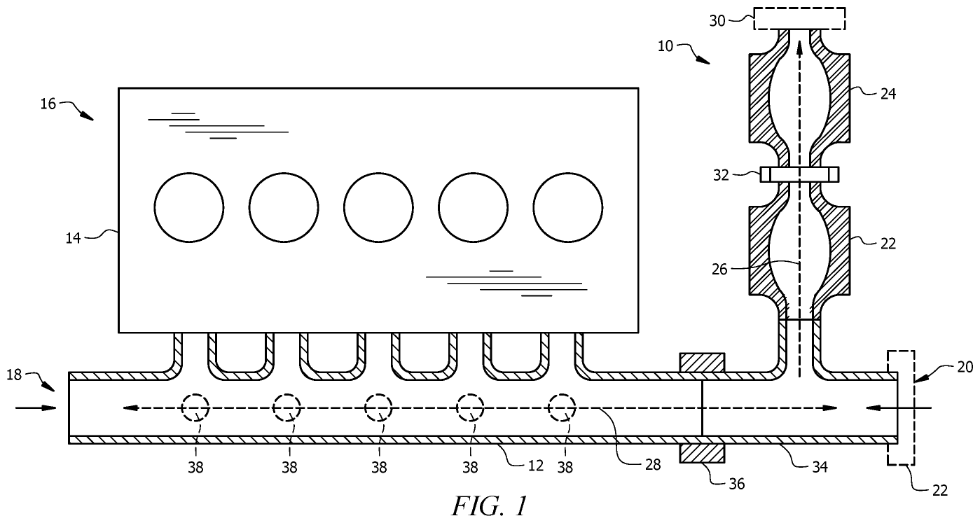

FIG. 1 is an illustrating of a modular suction stabilizer 10 for a suction manifold 12 for the fluid cylinder 14 of a pump 16. The suction manifold 12 includes a left-side flow entry port 18 and a right-side flow entry port 20 which can be closed off with an optional cap 22. The modular suction stabilizer 10 includes one or more modules (two shown) 22 and 24 connected sequentially to form a fluid relief path 26 that is in fluid communication with the primary fluid flow path 28 in the suction manifold 12 but is a branching fluid flow path apart from the primary fluid flow path. The stabilizer modules 22 and 24 are surrounded, encapsulated, or incorporates volume conforming and/or vibration absorbing/dampening materials that are capable of collapsing, compressing, and vibrating with pressure, such as rubber, silicon, polymers, elastomers, and any suitable material. The fluid relief path 26 is an alternate branching side path that is outside of the primary flow path 28 in the suction manifold 12. An optional cap 30 may be installed on the end stabilizing module 24 to terminate the flow release path 26. If more than one module is connected to the suction manifold 12, the number of modules in active operation can be modified by applying a terminating device 32, such as a clamp, valve, or another suitable component to terminate the fluid release path 26 at any desired point.

As shown in FIG. 1, the modular stabilizer 10 may include a segment of conduit 34 that may be coupled in-line with the suction manifold 12 that effectively extends the suction manifold 12. The connection between the suction manifold 12 and the conduit segment 34 may be secured with a conventional clamp 36. The stabilizer modules 22 and 24 may be coupled perpendicularly (or at an acute angle) to the conduit segment 34, forming an alternate fluid flow path. As shown in FIG. 1, the secondary fluid path 26 defined by the stabilizer modules 22 and 24 is oriented vertically from the axis of the suction manifold 12 and the primary fluid flow path 28. It is contemplated that more than one conduit segment 34 with the attendant stabilizer modules 22 and 24 may be coupled to the suction manifold 12 to form multiple alternate parallel fluid flow paths if the pump application and operating conditions demand it. In an alternate embodiment, the modular stabilizer 10 may be coupled to the suction manifold 12 via one or more of the clean-out ports 38 located laterally on the manifold, as shown in FIG. 1, and may extend generally laterally from the manifold 12.

In operation, as the fluid enters from the left-side flow entry port 18 and/or right-side flow entry port 20 and the fluid pressure in the suction manifold 12 increases, the fluid is forced into the stabilizer module(s) 22 and 24. The stabilizer modules 22 and 24 provide a fluid relief path 26 that is encased or encapsulated in a vibration dampening material that absorbs impact and stores the energy in the fluid. As a result, the suction manifold 12 experiences a drop or moderation in fluid pressure and relief for the vibration in the fluid. Thus, each stabilizer module 22 and 24 acts as a vibration absorber that prevents the any unintended or undesirable vibration and motion in the pump, suction manifold, and trailer.

It should be noted that the modular stabilizer 10 forms a fluid path that is separate and apart from the primary fluid path of the suction manifold 12. Because the modular stabilizer 10 forms a side flow path that is outside of the high-pressure main flow path 28 of the fluid in the suction manifold 12, wear and degradation to the stabilizing modules 22 and 24 is limited. Further, by moving the stabilizer 10 out of the primary flow path 28, there is no longer a need for a gas charge to control and maintain. The stabilizer solution described herein may be optimized with respect to dynamic pressure compliance for varying pumps and conditions without the need for a suction manifold re-design by varying the number of alternate fluid paths and the number of modules in the stabilizer.

Different pumps or application may require different number of stabilizer modules. The modular suction stabilizer 10 described herein may be easily customizable based on the pump and specific application by simply altering the number of modules that are deployed. As described above, a clamp 32 and a terminating cap 30 may be used to define the desired number of stabilization modules for the vibration dampening flow relief path 26.

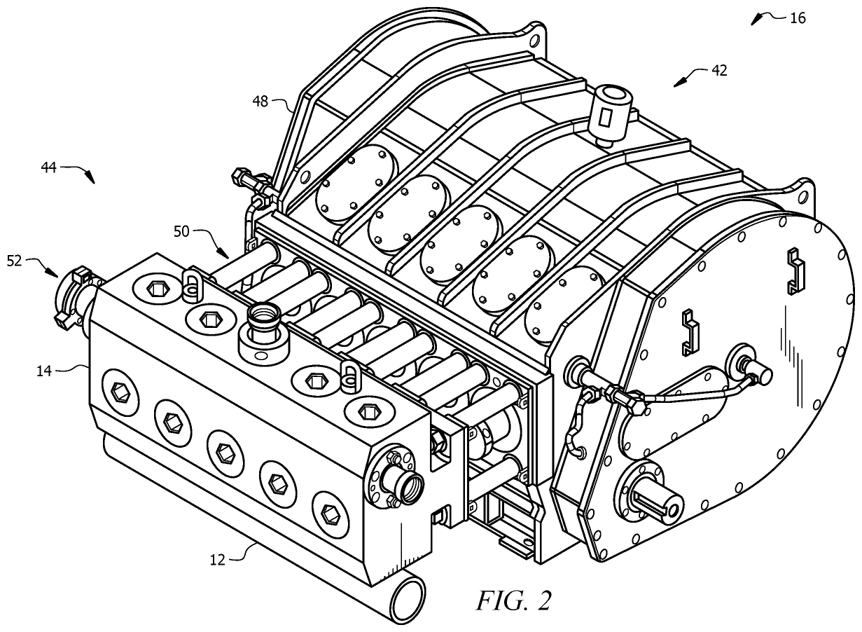

FIG. 2 is a pictorial representation of an exemplary positive displacement or reciprocating pump 40 that would benefit from the vibration dampening function of the modular stabilizer 10. The positive displacement pump 40 has two sections, a power end 42 and a fluid end 44. The fluid end 44 of the pump 40 includes a fluid end block or fluid cylinder 46, which is connected to the power end housing 48 via a plurality of stay rods 50. In operation, the crankshaft (not explicitly shown) reciprocates a plunger rod assembly between the power end 42 and the fluid end 44. The crankshaft is powered by an engine or motor (not explicitly shown) that drives a series of plungers (not explicitly shown) to create alternating high and low pressures inside a fluid chamber. The cylinders operate to draw fluid into the fluid chamber via a suction manifold 12 and then discharge the fluid at a high pressure to a discharge manifold 52 via valves. The discharged liquid is then injected at high pressure into an encased wellbore. The injected fracturing fluid is also commonly called a slurry, which is a mixture of water, proppants (silica sand or ceramic), and chemical additives. The pump can also be used to inject a cement mixture down the wellbore for cementing operations. The pump may be freestanding on the ground, mounted to a skid, or mounted to a trailer.

The features of the present invention which are believed to be novel are set forth below with particularity in the appended claims. However, modifications, variations, and changes to the exemplary embodiments described above will be apparent to those skilled in the art, and the modular suction stabilizer described herein thus encompasses such modifications, variations, and changes and are not limited to the specific embodiments described herein.

What is claimed is:

1. A modular stabilizer for coupling to a suction manifold of a reciprocating pump, the suction manifold defining a first fluid flow path between two fluid entry ports, comprising at least one fluid dampening module forming a second fluid flow path in fluid communication with the first fluid flow path, the second fluid flow path being an alternate fluid flow path branching from the first fluid flow path.

2. The modular stabilizer of claim 1, wherein the at least one fluid dampening module is encapsulated by a vibration dampening material.

3. The modular stabilizer of claim 1, wherein the at least one fluid dampening module incorporates a vibration dampening material.

4. The modular stabilizer of claim 1, wherein the second flow path defined by the at least one fluid dampening module is substantially perpendicular to the first fluid flow path.

5. The modular stabilizer of claim 1, wherein the at least one fluid dampening module comprises at least two fluid dampening modules coupled in linear alignment to form a linear fluid flow path.

6. The modular stabilizer of claim 1, wherein the at least one fluid dampening module comprises at least two fluid dampening modules coupled in parallel to the suction manifold, forming at least two second fluid flow paths in fluid communication with the first fluid flow path.

7. The modular stabilizer of claim 1, further comprising at least one fluid dampening module coupled to the suction manifold and forming a third fluid flow path in fluid communication with the first fluid flow path, the third fluid flow path being separate and apart from the second fluid flow path.

8. The modular stabilizer of claim 1, wherein each fluid dampening module comprises a fluid path segment and the modular stabilizer comprises a device to terminate flow between any two fluid path segments.

9. The modular stabilizer of claim 1, wherein each fluid dampening module comprises a fluid path segment and the modular stabilizer comprises a clamp to terminate flow between any two fluid path segments.

10. The modular stabilizer of claim 1, further comprising a terminating cap coupled to one of the at least one fluid dampening module and configured to terminate the second fluid flow path.

11. The modular stabilizer of claim 1, further comprising a conduit segment coupled to the at least one fluid dampening module and configured for coupling to one of the two fluid entry ports of the suction manifold.

12. A modular stabilizer coupled to a suction manifold of a reciprocating pump, comprising at least one fluid path segment incorporating a vibration dampening material and defining a secondary fluid flow path branching from a primary fluid flow path formed between two fluid entry ports of the suction manifold.

13. The modular stabilizer of claim 12, wherein the at least one fluid path segment comprises a plurality of fluid path segments coupled in linear alignment to create the secondary fluid flow path branching from the primary fluid flow path.

14. The modular stabilizer of claim 13, comprising a clamp configured to terminate the fluid flow path between any two fluid path segments.

15. The modular stabilizer of claim 13, further comprising a cap configured to terminate the secondary fluid flow path.

16. The modular stabilizer of claim 13, further comprising a second plurality of fluid path segments coupled in linear alignment to create a third fluid flow path also branching from the primary fluid flow path.

17. The modular stabilizer of claim 12, wherein at least one fluid path segment is encapsulated by a vibration dampening material.

18. The modular stabilizer of claim 12, further comprising a conduit segment coupled to the at least one fluid path segment and configured for coupling to one of the two fluid entry ports of the suction manifold.

19. The modular stabilizer of claim 12, wherein the secondary fluid flow path defined by the at least one fluid path segment is substantially perpendicular to the primary fluid flow path between the two fluid entry ports of the suction manifold.

20. A modular vibration dampener coupled to a suction manifold of a high-pressure pump, the modular vibration dampener comprising:
a plurality of fluid dampening modules coupled to the suction manifold forming a secondary fluid flow path in fluid communication with a primary fluid flow path in fluid communication with a fluid entry port of the suction manifold, the secondary fluid flow path being an alternate fluid flow path branching from the primary fluid flow path;
the plurality of fluid dampening modules incorporating a vibration dampening material; and
a device being configured for terminating fluid flow between any two adjacent fluid dampening modules.
